(19) United States
(12) Patent Application Publication
(10) Pub. No.: US 2024/0169215 A1
(43) Pub. Date: May 23, 2024

(54) Machine Learning Model-Based Anomaly Prediction and Mitigation

(71) Applicant: Disney Enterprises, Inc., Burbank, CA (US)

(72) Inventors: Thiago Borba Onofre, Winter Garden, FL (US); Michael Tschanz, Orlando, FL (US); Brian F. Walters, Groveland, FL (US); Chun Sum Yeung, Orlando, FL (US); Ting-Yen Wang, Windermere, FL (US); Amber E. Weyand, Windermere, FL (US)

(21) Appl. No.: 17/991,524

(22) Filed: Nov. 21, 2022

(51) Int. Cl. G06N 5/022

(52) U.S. Cl. CPC G06N 5/022

(57) ABSTRACT

A system includes a processor and a memory storing software code and a machine learning (ML) model. The software code is executed to receive contextual data samples each including raw data and a descriptive label, for each contextual data sample: search a database for a data pattern matching the raw data, determine, when the data pattern is detected, whether the data pattern is correlated with an anomalous event, and generate, when the correlation is determined, training data including a label identifying the anomalous event, and the raw data, the data pattern, or both, to provide one of multiple training data samples, wherein the training data samples describe anomalous events corresponding respectively to the raw data, the data pattern, or both. The software code is further executed to train the ML model, using the training data samples, to provide a trained predictive ML model configured to predict the anomalous events.

### BACKGROUND

Industrial control systems may be used to monitor the performance of hundreds or thousands of machines based on data received from hundreds of thousands of digital and analog sensors. A conventional approach to making use of this abundance of data is to set “normal” or expected ranges for each sensor, and to compare the sensor data being received to those acceptable ranges. When sensor data strays outside of such acceptable ranges, a fault condition may be flagged automatically. Alternatively, or in addition, system operators trained to look for irregularities in sensor data may monitor the data being received from the sensors and either proactively initiate a maintenance inspection of a machine or override an automated fault flag.

Both conventional approaches have their drawbacks. Flagging mechanical faults automatically based on the comparison of sensor data to predetermined ranges tends undesirably to produce many false positives, resulting in unnecessary equipment shutdowns, maintenance inspections, and their attendant delays. In addition, automated range based fault flags are merely reactive, and offer no means to preemptively avoid the fault condition. Relying on human expertise, while more forward looking than responding to automated fault flags, is expensive due to the training and experience required for a system operator to achieve competence. Moreover, when a trained system operator retires or leaves one company to work for another, the expertise of that individual is lost to the company having invested in that training and experience. Consequently, there is a need in the art for an industrial control solution that is capable of acquiring human expertise while automating the prediction and mitigation of anomalous events.

### BRIEF DESCRIPTION OF THE DRAWINGS

FIG. 1 shows an exemplary system for performing machine-learning (ML) model-based anomaly prediction and mitigation, according to one implementation;

FIG. 2 shows a user interface (UI) of the system shown in FIG. 1, displaying sensor data including raw data and a descriptive label applied to the raw data by a system operator, according to one implementation;

FIG. 3A shows a flowchart presenting an exemplary method for performing ML model-based anomaly prediction and mitigation, according to one implementation; and

FIG. 3B shows a flowchart including additional actions for extending the exemplary method outlined in FIG. 3A, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing machine-learning (ML) model-based anomaly prediction and mitigation. As described above, conventional approaches to utilizing the data generated by the sometimes hundreds of thousands of digital and analog sensors used by industrial control systems have significant drawbacks. Flagging mechanical faults automatically based on the comparison of sensor data to predetermined “normal” or expected data ranges tends undesirably to produce many false positives, resulting in unnecessary equipment shutdowns, maintenance inspections, and their attendant delays. In addition, automated data range based fault flags are merely reactive, and offer no means to preemptively avoid fault conditions. Relying instead on human expertise, while more forward looking than responding to automated fault flags, is expensive due to the training and experience required for a system operator to achieve competence. Moreover, and as noted above, when a trained system operator retires or leaves one company to work for another, the expertise of that individual is undesirably lost to the company having invested in that training and experience.

In addition to the drawbacks of conventional approaches described above, the increasing complexity and interconnectedness of the machines utilized in modern industrial systems, as well as the increasing sensitivity of modern sensors, result in the generation and collection of quantities of data that simply defy the capacity of the human mind to interpret, even with the assistance of the processing and memory resources of a general purpose computer. The novel and inventive systems and methods disclosed in the present application advance the state-of-the-art by introducing an artificial intelligence (AI) inspired automated ML model-based anomaly prediction and mitigation solution capable of ingesting the raw data generated by system sensors, detecting patterns in that raw data, predicting anomalous events using those data patterns, and, in some implementations, identifying strategies for mitigating or eliminating the predicted anomalous events.

As used in the present application, the terms “automation.” “automated.” and “automating” refer to systems and processes that do not require the participation of a human system operator. Although, in some implementations, a system operator or administrator may review, ratify, or override the anomalous event predictions made, or the strategies for mitigation or elimination of those anomalous events identified by the automated systems and according to the automated methods described herein, that human involvement is optional. Thus, the methods described in the present application may be performed under the control of hardware processing components of the disclosed automated systems.

It is also noted that, as defined in the present application, the expression “machine learning model” may refer to a mathematical model for making future predictions based on patterns learned from samples of data or “training data.” For example, machine learning models may be trained to perform image processing, natural language processing (NLP), and other inferential data processing tasks. Various learning algorithms can be used to map correlations between input data and output data. These correlations form the mathematical model that can be used to make future predictions on new input data. Such a predictive model may include one or more logistic regression models, Bayesian models, or artificial neural networks (NNs). A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network. It is noted that the use of an ML model specifically configured and trained to predict anomalous events using training data that embodies the expertise of trained and experienced human system operators represents a significant advantage of the present solution over conventional solution that do not harness the inferencing power of ML models.

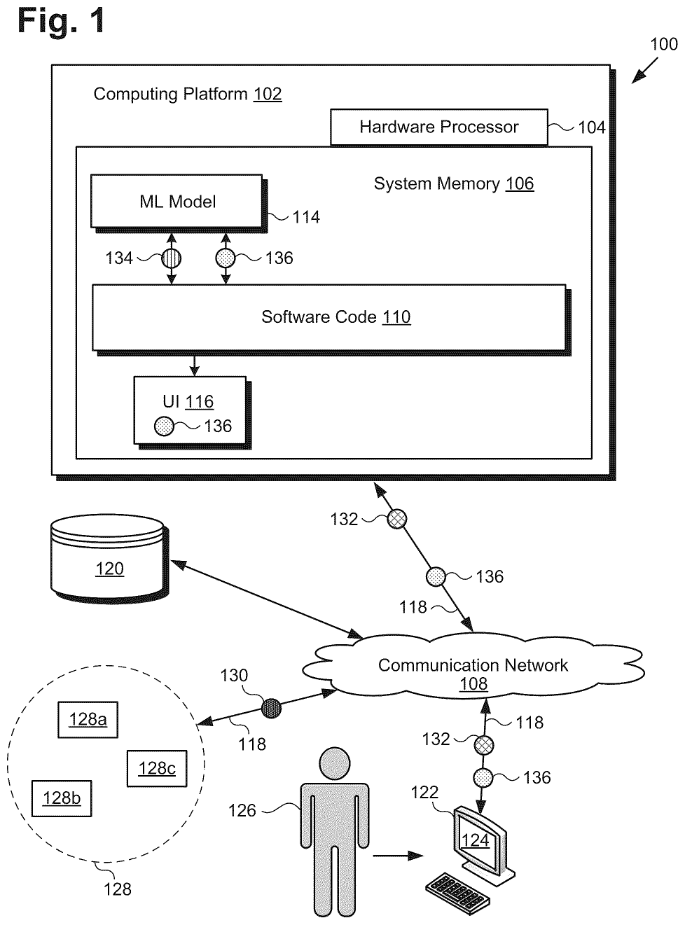

FIG. 1 shows exemplary system 100 for performing ML model-based anomaly prediction and mitigation, according to one implementation. As shown in FIG. 1, system 100 includes computing platform 102 having hardware processor 104 and system memory 106 implemented as a computer-readable non-transitory storage medium. According to the present exemplary implementation, system memory 106 stores software code 110 and ML model 114. Also shown in FIG. 1 is user interface (UI) 116 provided by software code 110.

As further shown in FIG. 1, system 100 is implemented within a use environment including communication network 108, database 120, user system 122 including display 124, and user 126 of system 100 and user system 122. In addition. FIG. 1 shows sensors 128 including individual sensors 128a, 128b, and 128c. Also shown in FIG. 1 are sensor data 130, contextual data samples 132, training data samples 134, and prediction 136, as well as network communication links 118 of communication network 108 interactively connecting system 100 with sensors 128, user system 122, and database 120.

It is noted that although sensors 128 are shown to include three sensors, 128a, 128b, and 128c, that representation is merely exemplary. In other implementations, sensors 128 may include more than three sensors, such as hundreds, thousands, tens of thousands, hundreds of thousands, or millions of sensors, for example. Although database 120 is depicted as a database remote from system 100 and accessible via communication network 108 and network communication links 118, that representation too is merely by way of example. In other implementations, database 120 may be included as a feature of system 100 and may be stored in system memory 106. With respect to database 120, it is further noted that, in some implementations, database 120 may include a data lake storing all or substantially all historical sensor data generated by sensors 128.

Although the present application refers to software code 110 and ML model 114 as being stored in system memory 106 for conceptual clarity, more generally, system memory 106 may take the form of any computer-readable non-transitory storage medium. The expression “computer-readable non-transitory storage medium.” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs such as DVDs, RAM, programmable read-only memory (PROM), erasable PROM (EPROM), and FLASH memory.

Moreover, although FIG. 1 depicts to software code 110 and ML model 114 as being co-located in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. Consequently, in some implementations, software code 110 and ML model 114 may be stored remotely from one another on the distributed memory resources of system 100. It is also noted that, in some implementations, ML model 114 may take the form of one or more software modules included in software code 110.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for AI processes such as machine learning.

In some implementations, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth, for instance. Furthermore, in some implementations, system 100 may be implemented virtually, such as in a data center. For example, in some implementations, system 100 may be implemented in software, or as virtual machines. Moreover, in some implementations, communication network 108 may be a high-speed network suitable for high performance computing (HPC), for example a 10 GigE network or an Infiniband network.

It is further noted that, although user system 122 is shown as a desktop computer in FIG. 1, that representation is provided merely by way of example. In other implementations, user system 122 may take the form of any suitable mobile or stationary computing device or system that implement data processing capabilities sufficient to support UI 116, as well as connections to communication network 108, and implement the functionality ascribed to user system 122 herein. That is to say, in other implementations, user system 122 may take the form of a laptop computer, tablet computer, or smartphone, to name a few examples. Alternatively, in some implementations, user system 122 may be a “dumb terminal” peripheral device of system 100. In those implementations, system 122 may be controlled by hardware processor 104 of computing platform 102.

It is also noted that display 124 of user system 122 may take the form of a liquid crystal display (LCD), a light-emitting diode (LED) display, an organic light-emitting diode (OLED) display, a quantum dot (QD) display, or any other suitable display screen that perform a physical transformation of signals to light. Furthermore, display 124 may be physically integrated with user system 122 or may be communicatively coupled to but physically separate from user system 122. For example, where user system 122 is implemented as a smartphone, laptop computer, or tablet computer, display 124 will typically be integrated with user system 122. By contrast, where user system 122 is implemented as a desktop computer, display 124 may take the form of a monitor separate from user system 122 in the form of a computer tower.

By way of overview, user 126, who may be a trained and experienced operator of system 100 for example, (hereinafter “system operator 126”) may interact with system 100 via user system 122 and UI 116 provided by software code 110 of system 100. System operator 126 may utilize user system 122 and UI 116 to obtain sensor data 130 from some or all of sensors 128, may review sensor data 130, and may generate contextual data samples 132 each including raw data from sensor data 130 and a descriptive label for that raw data applied by system operator 126. Examples of such descriptive labels include “normal,” “abnormal.” “in range.” “out of range.” and “fault,” to name a few.

Contextual data samples 132 may be received by system 100 from user system 122 via communication network 108 and network communication links 118. For each contextual data sample included among contextual data samples 132, hardware processor 104 of system 100 may execute software code 110 to search database 120, using a predetermined matching criterion, for a data pattern matching the raw data included in that contextual data sample, determine, when a matching data pattern is found, whether there is a correlation between that matching data pattern and an anomalous event, and generate, when the correlation is determined to exist, one of training data samples 134 including a label identifying the anomalous event and at least one of the raw sensor data or the matching data pattern. Software code 110 may then be executed by hardware processor 104 to train ML model 114, which may take the form of a transformer network for example, using training data samples 134, to provide a trained predictive ML model configured to predict anomalous events in the future. In other words, ML model 114 is configured to ingest the training and experience of system operator 126 as a result of being trained based on contextual data samples 132 provided by system operator 126.

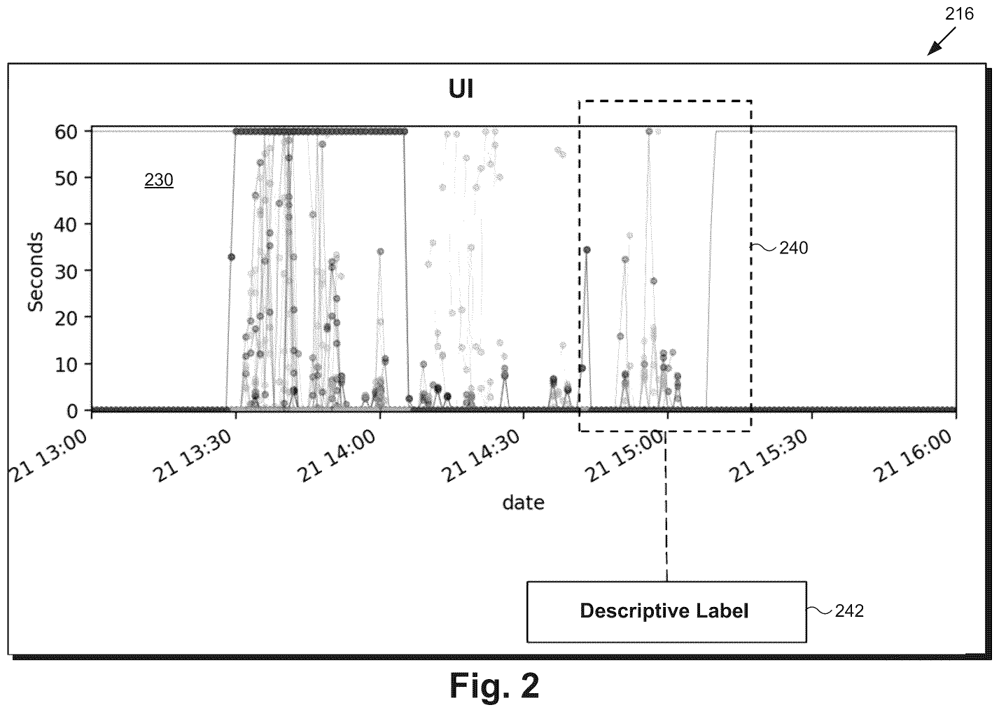

FIG. 2 shows UI 216 displaying sensor data 230 including raw data 240 and descriptive label 242 applied to raw data 240 by a system operator, such as system operator 126 in FIG. 1, according to one implementation. UI 216 and sensor data 230 correspond respectively in general to UI 116 and sensor data 130, in FIG. 1. Consequently. UI 116 and sensor data 130 may share any of the characteristics attributed to respective UI 216 and sensor data 230 by the present disclosure, and vice versa. Moreover, and as shown in FIG. 2, in some implementations, sensor data 130/230 including raw data 240 may take the form of time series data.

Referring to FIGS. 1 and 2 in combination, system operator 126 may utilize UI 116/216 and user system 122 to selectively sample sensor data 130/230 produced by various combinations of sensors 128. When, based on the training and experience of system operator 126, system operator 126 detects raw data 240 that appears to be of interest or significance within sensor data 130/230, system operator 126 may apply descriptive label 242 to raw data 240 and provide a contextual data sample including raw data 240 and descriptive label 242. As noted above, examples of descriptive labels 242 applied by system operator 126 may include “normal.” “abnormal,” “in range,” “out of range,” and “fault,” to name a few. It is noted that in some implementations, descriptive label 242 may be selectable by system operator from a predetermined and closed taxonomy of labels to ensure consistency in labeling.

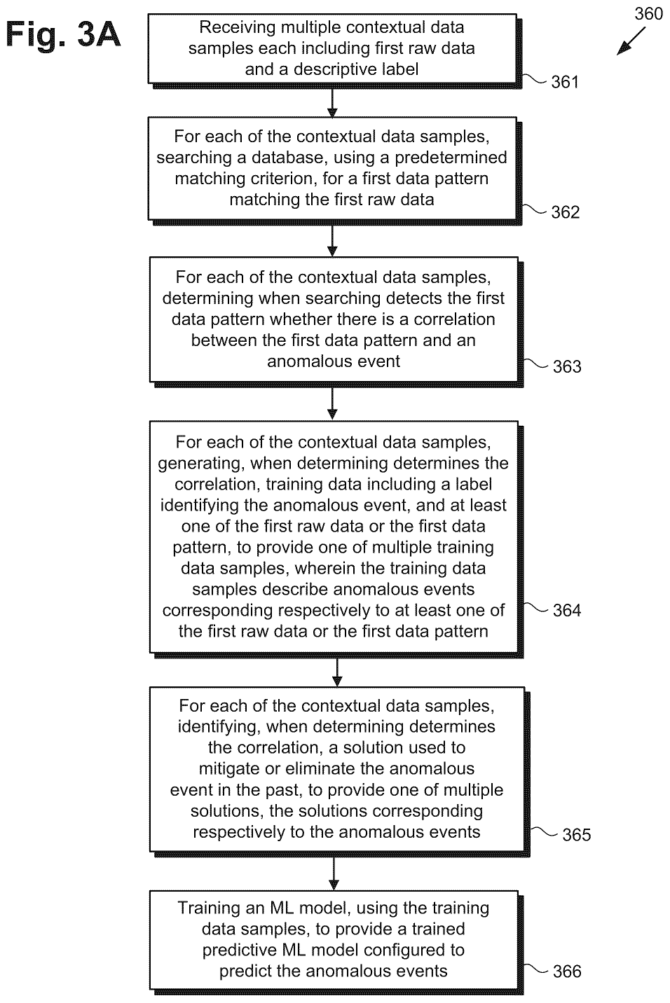

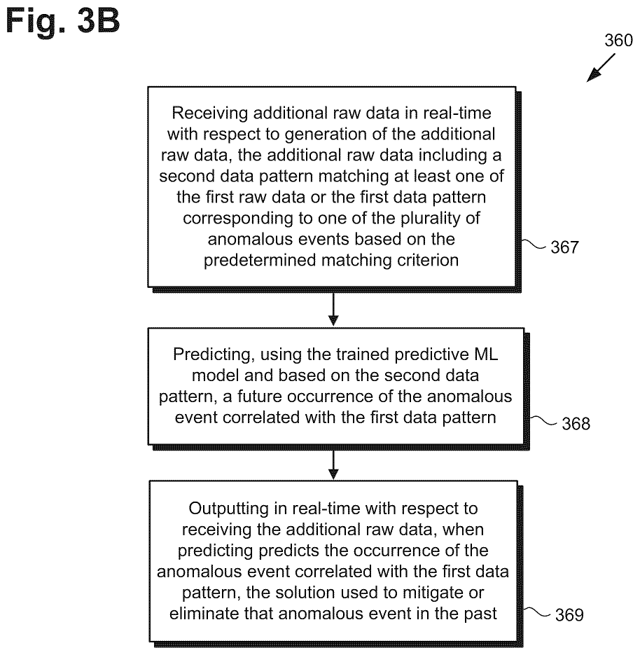

The functionality of system 100 and software code 110 will be further described by reference to FIGS. 3A and 3B. FIG. 3A shows flowchart 360 presenting an exemplary method for performing ML model-based anomaly prediction and mitigation, according to one implementation, while FIG. 3B shows additional actions for extending the method outlined in FIG. 3A, according to one implementation. With respect to the actions described in FIGS. 3A and 3B, it is noted that certain details and features have been left out of flowchart 360 in order not to obscure the discussion of the inventive features in the present application.

Referring to FIG. 3A in combination with FIGS. 1 and 2, flowchart 360 begins with receiving multiple contextual data samples 132 each including raw data 240 (hereinafter “first raw data 240”) and descriptive label 242 (action 361). As noted above, system operator 126 may utilize UI 116/216 and user system 122 to selectively sample sensor data 130/230 produced by various combinations of sensors 128. When, based on the training and experience of system operator 126, system operator 126 detects first raw data 240 to be data of interest or significance, system operator 126 may apply descriptive label 242 to first raw data 240 and provide a contextual data sample including first raw data 240 and descriptive label 242. Those actions by system operator 126 may be repeated to provide multiple contextual data samples 132. Those contextual data samples 132 may be received from user system, in action 361, by software code 110, executed by hardware processor 104 of system 100, and via communication network 108 and network communication links 118. As also noted above, first raw data 240 may include one or both of digital sensor data or analog sensor data, which may take the form of time series data generated by some or all of sensors 128.

Continuing to refer to FIGS. 1, 2, and 3A in combination, flowchart 360 further includes, for each of contextual data samples 132, searching database 120, using a predetermined matching criterion, for a data pattern matching first raw data 240 (hereinafter “first data pattern”) (action 362). Action 362 may be performed using any one or more conventional data matching algorithms, or using a programmed loop, as known in the art, and may be performed deterministically or probabilistically. In some implementations, the predetermined matching criterion may be a fixed parameter of the data matching algorithm being used, while in other implementations, the predetermined matching criterion may be selectable by a system administrator of system 100, or by system operator 126. The searching of database 120 in action 362 may be performed by software code 110, executed by hardware processor 104 of system 100.

Continuing to refer to FIGS. 1, 2, and 3A in combination, flowchart 360 further includes, for each of contextual data samples 132, determining, when the searching performed in action 362 detects the first data pattern, whether there is a correlation between that first data pattern and an anomalous event (action 363). It is noted that, as defined for the purposes of the present application, the expression “anomalous event” refers to any instance in which a machine or other component of system 100 fails, exhibits a fault, or operates in a manner that results in sensor data for that component exceeding or falling below normal or expected ranges.

In some implementations, the determination performed in action 363 may be made by reference to database 120, which may store the first data pattern detected in action 362, as well as data describing the nature, timing, and system impact of historical anomalous events. Correlation of the first data pattern to an anomalous event may be based on a timing relation between the generation of the first data pattern by one or more of sensors 128 and the occurrence of the anomalous event, may be based on a nexus among one or more sensors 128 generating the first data pattern and one or more components of system 100 affected by the anomalous event, or any combination thereof. The determination as to whether a correlation between the first data pattern detected in action 362 and an anomalous event exists may be performed in action 363 by software code 110, executed by hardware processor 104 of system 100.

Continuing to refer to FIGS. 1, 2, and 3A in combination, flowchart 360 further includes, for each of contextual data samples 132, generating, when the determination performed in action 363 determines that the correlation exists, training data including a label identifying the anomalous event correlated with the first data pattern, and at least one of first raw data 240 or the first data pattern matching first raw data 240, to provide one of multiple training data samples 134, where each of training data samples 134 describes an anomalous event corresponding respectively to one or both of first raw data 240 or its matching first data pattern included in that particular contextual data sample (action 364). The generation of training data samples 134 in action 364 may be performed by software code 110, executed by hardware processor 104 of system 100.

Continuing to refer to FIGS. 1, 2, and 3A in combination, in some implementations flowchart 360 may optionally include, for each of contextual data samples 132, identifying, when the determination performed in action 363 determines that the correlation exists, a solution used to one of mitigate or eliminate the anomalous event correlated with the first data pattern in the past, to provide one of multiple solutions each corresponding respectively to an anomalous event (action 365). In some implementations, action 365 may be performed by reference to database 120, which, in addition to storing historical sensor data and a history of anomalous events, may also store previously employed solutions for mitigating or eliminating those anomalous events. Action 365, when performed, advantageously avoids having to rediscover or reinvent solutions that have shown success in the past. Action 365, when performed, may be performed by software code 110, executed by hardware processor 104 of system 100.

As noted above, action 365 is optional and in some implementations may be omitted from the method outlined by flowchart 360. However, in implementations in which action 365 is performed, action 365 may follow directly from action 364, as represented in FIG. 3A, or may be performed in parallel with, i.e., contemporaneously with, action 364.

Continuing to refer to FIGS. 1, 2, and 3A in combination, flowchart 360 further includes training ML model 114, using training data samples 134, to provide a trained predictive ML model (i.e., trained ML model 114) configured to predict the anomalous events described above by reference to actions 363, 364, and optional action 365 (action 366). As noted above, in some implementations, ML model 114 may take the form of a transformer network. In those implementations, action 366 provides a trained predictive transformer network configured to predict anomalous events in the future based on sensor data 130/230. The training of ML model 114 in action 366 may be performed by software code 110, executed by hardware processor 104 of system 100.

In some implementations, the method described by reference to flowchart 360 may conclude with action 366 described above. However, as shown by FIG. 3B, in some implementations, the method outlined in FIG. 3A may be extended by the additional actions described by reference to FIG. 3B.

Referring to FIG. 3B in combination with FIGS. 1 and 2, flowchart 360 may further include receiving additional raw data in real-time with respect to generation of the additional raw data, the additional raw data including a second data pattern matching at least one of first raw data 240 or the first data pattern corresponding to one of the anomalous events, based on the predetermined matching criterion used in action 362 (action 367). With respect to the characterization “in real-time,” as defined for the purposes of the present application, “in real-time” with respect to an event or occurrence refers to a time interval of less than ten seconds (10s), up to approximately 60s from the time of the event or occurrence.

Like first raw data 240, the additional raw data received in action 367 may include one or both of digital sensor data or analog sensor data, which may take the form of time series data generated by some or all of sensors 128. The second raw data may be received from one or more of sensors 128, in action 367, by software code 110, executed by hardware processor 104 of system 100, and via communication network 108 and network communication links 118.

Continuing to refer to FIGS. 1, 2, and 3B in combination, flowchart 360 further includes predicting, using trained predictive ML model 114 and based on the second data pattern included in the additional raw data received in action 367, the occurrence of the anomalous event correlated with the first data pattern (action 368). Action 368 may be performed by software code 110, executed by hardware processor 104 of system 100, and using trained predictive ML model 114 to provide prediction 136, which may be displayed to system operator 126 via UI 116/216.

In some implementations, the method outlined by flowchart 360 may conclude with action 368 described above. However, in implementations in which action 365 is performed, flowchart 360 may further include outputting in real-time with respect to receiving the additional raw data in action 367, when predicting predicts the occurrence of the anomalous event correlated with the first data pattern, the solution for mitigating or eliminating that anomalous event 369. Action 369 may be performed by software code 110, executed by hardware processor 104 of system 100. It is noted that in implementations in which the method outlined by flowchart 360 includes action 369, action 369 may follow directly from action 368, as represented in FIG. 3B, or may be performed in parallel with, i.e., contemporaneously with, action 368.

With respect to the method outlined by flowchart 360, it is noted that, in various implementations, actions 361, 362, 363, and 364 (hereinafter “actions 361-364”), and 366, or actions 361-364, 365, and 366 (hereinafter “actions 361-366”), or actions 361-364 and actions 366, 367, and 368 (hereinafter “actions 366-368”), or actions 361-366, 367, and 368 (hereinafter “actions 361-368”), or actions 361-368 and 369, may be performed in an automated process from which human participation may be omitted.

Thus, the present application discloses systems and methods for providing ML model-based anomaly detection and mitigation. The novel and inventive systems and methods disclosed in the present application advantageously advance the state-of-the-art by introducing an AI inspired automated ML model-based anomaly prediction and mitigation solution capable of ingesting the raw data generated by system sensors, detecting patterns in that raw data based on contextual data used to train the ML model, predicting anomalous events using those data patterns, and, in some implementations, identifying solutions for mitigating or eliminating the predicted anomalous events.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor and a system memory storing a software code and a machine learning (ML) model;
the hardware processor configured to execute the software code to:
receive a plurality of contextual data samples, each of the plurality of contextual data samples including first raw data and a descriptive label;
for each of the plurality of contextual data samples:
search a database, using a predetermined matching criterion, for a first data pattern matching the first raw data;
determine, when searching detects the first data pattern, whether there is a correlation between the first data pattern and an anomalous event;
generate, when determining determines the correlation, training data including a label identifying the anomalous event, and at least one of the first raw data or the first data pattern, to provide one of a plurality of training data samples, wherein the plurality of training data samples describe a plurality of anomalous events corresponding respectively to the at least one of the first raw data or the first data pattern; and
train the ML model, using the plurality of training data samples, to provide a trained predictive ML model configured to predict the plurality of anomalous events.

2. The system of claim 1, wherein the hardware processor is further configured to execute the software code to:
receive additional raw data in real-time with respect to generation of the additional raw data, the additional raw data including a second data pattern matching at least one of the first raw data or the first data pattern corresponding to one of the plurality of anomalous events based on the predetermined matching criterion; and
predict, using the trained predictive ML model and based on the second data pattern, an occurrence of the one of the plurality of anomalous events.

3. The system of claim 2, wherein the additional raw data comprises time series data generated by a plurality of sensors, wherein the additional raw data is received from the plurality of sensors.

4. The system of claim 2, wherein the hardware processor is further configured to execute the software code to:
for each of the plurality of contextual data samples:
identify, when determining determines the correlation, a solution used to one of mitigate or eliminate the anomalous event in the past, to provide one of a plurality of solutions, the plurality of solutions corresponding respectively to the plurality of anomalous events; and
output in real-time with respect to receiving the additional raw data, when predicting predicts the occurrence of the one of the plurality of anomalous events, the solution corresponding to the one of the plurality of anomalous events.

5. The system of claim 1, wherein the first raw data comprises time series data.

6. The system of claim 1, wherein the first raw data comprises at least one of analog sensor data or digital sensor data generated by a plurality of sensors.

7. The system of claim 1, wherein the ML model comprises a transformer network.

8. A method for use by a system including a hardware processor and a system memory storing a software code and a machine learning (ML) model, the method comprising:
receiving, by the software code executed by the hardware processor, a plurality of contextual data samples, each of the plurality of contextual data samples including first raw data and a descriptive label;
for each of the plurality of contextual data samples:
searching a database, by the software code executed by the hardware processor and using a predetermined matching criterion, for a first data pattern matching the first raw data;
determining, by the software code executed by the hardware processor when searching detects the first data pattern, whether there is a correlation between the first data pattern and an anomalous event;
generating, by the software code executed by the hardware processor when determining determines the correlation, training data including a label identifying the anomalous event, and at least one of the first raw data or the first data pattern, to provide one of a plurality of training data samples, wherein the plurality of training data samples describe a plurality of anomalous events corresponding respectively to the at least one of the first raw data or the first data pattern; and
training the ML model, by the software code executed by the hardware processor, using the plurality of training data samples, to provide a trained predictive ML model configured to predict the plurality of anomalous events.

9. The method of claim 8, further comprising:
receiving, by the software code executed by the hardware processor, additional raw data in real-time with respect to generation of the additional raw data, the additional raw data including a second data pattern matching at least one of the first raw data or the first data pattern corresponding to one of the plurality of anomalous events based on the predetermined matching criterion; and
predicting, using the trained predictive ML model, by the software code executed by the hardware processor and based on the second data pattern, an occurrence of the one of the plurality of anomalous events.

10. The method of claim 9, wherein the additional raw data comprises time series data generated by a plurality of sensors, wherein the additional raw data is received from the plurality of sensors.

11. The method of claim 9, further comprising:
for each of the plurality of contextual data samples:
identifying, by the software code executed by the hardware processor when determining determines the correlation, a solution used to one of mitigate or eliminate the anomalous event in the past, to provide one of a plurality of solutions, the plurality of solutions corresponding respectively to the plurality of anomalous events; and
outputting in real-time with respect to receiving the additional raw data, by the software code executed by the hardware processor when predicting predicts the occurrence of the one of the plurality of anomalous events, the solution corresponding to the one of the plurality of anomalous events.

12. The method of claim 8, wherein the first raw data comprises time series data.

13. The method of claim 8, wherein the first raw data comprises at least one of analog sensor data or digital sensor data generated by a plurality of sensors.

14. The method of claim 8, wherein the ML model comprises a transformer network.

15. A computer-readable non-transitory storage medium having stored thereon a software code, which when executed by a hardware processor performs a method comprising:
receiving a plurality of contextual data samples, each of the plurality of contextual data samples including first raw data and a descriptive label;
for each of the plurality of contextual data samples:
searching a database, using a predetermined matching criterion, for a first data pattern matching the first raw data;
determining, when searching detects the first data pattern, whether there is a correlation between the first data pattern and an anomalous event;
generating, training data including a label identifying the anomalous event, and at least one of the first raw data or the first data pattern, to provide one of a plurality of training data samples, wherein the plurality of training data samples describe a plurality of anomalous events corresponding respectively to the at least one of the first raw data or the first data pattern; and
training a machine learning (ML) model, using the plurality of training data samples, to provide a trained predictive ML model configured to predict the plurality of anomalous events.

16. The computer-readable non-transitory storage medium of claim 15, the method further comprising:
receiving additional raw data in real-time with respect to generation of the additional raw data, the additional raw data including a second data pattern matching at least one of the first raw data or the first data pattern corresponding to one of the plurality of anomalous events based on the predetermined matching criterion; and
predicting, using the trained predictive ML model and based on the second data pattern, an occurrence of the one of the plurality of anomalous events.

17. The system of claim 16, wherein the additional raw data comprises time series data generated by a plurality of sensors, wherein the additional raw data is received from the plurality of sensors.

18. The computer-readable non-transitory storage medium of claim 16, the method further comprising:
for each of the plurality of contextual data samples:
identifying, when determining determines the correlation, a solution used to one of mitigate or eliminate the anomalous event in the past, to provide one of a plurality of solutions, the plurality of solutions corresponding respectively to the plurality of anomalous events; and
outputting in real-time with respect to receiving the additional raw data, when predicting predicts the occurrence of the one of the plurality of anomalous events, the solution corresponding to the one of the plurality of anomalous events.

19. The computer-readable non-transitory storage medium of claim 15, wherein the first raw data comprises time series data.

20. The computer-readable non-transitory storage medium of claim 15, wherein the ML model comprises a transformer network.
